(19) United States
(12) Patent Application Publication
(10) Pub. No.: US 2010/0268592 A1
(43) Pub. Date: Oct. 21, 2010

(54) PAPERLESS CONSUMER COUPON SYSTEM AND METHOD

(76) Inventor: Steven J. SHAER, Miami, FL (US)

Correspondence Address: The Villamar Firm PLLC, 3424 Washington Drive, Falls Church, VA, 22041, US

(21) Appl. No.: 12/426,842

(22) Filed: Apr. 20, 2009

(51) Int. Cl. G06Q 30/00; H04Q 5/22

(52) U.S. Cl. 705/14.38; 340/10.3

(57) ABSTRACT

A system, method and computer program product for promotion processing and delivery, including a smart phone having a capture function for capturing a product code of an item, wherein the smart phone is configured to generate and display a promotion having a barcode based on the captured product code of the item; and a point-of-sale terminal configured to read the displayed barcode of the promotion from the display of the smart phone, wherein the point-of-sale terminal applies the promotion based on the read barcode to a sales transaction.

### BACKGROUND OF THE INVENTION

1. Field of the Invention

The present invention generally relates to systems and methods for coupon delivery and processing, and more particularly to a system and method for paperless dispensing, presenting, and processing of consumer discount coupons.

2. Discussion of the Background

With the increase in postal rates and the demise of print advertising consumer products companies are finding it more difficult and expensive to distribute coupons to consumers. This is further compounded by the fact that some of the most desirable consumers are young adults who have a particular disdain for both newspaper media and being influenced by direct mail. At the same time, the line between cell phone and a full fledged computer is getting more and more blurry as cell phones are taking on more and more computer functions and have more computer power. These “smart phones,” such as the Apple iPhone, the Research in Motion Blackberry phones, and the like, have a range of capabilities that go far beyond the simple telephone and include Internet access, computer applications and global positioning system (GPS) satellite navigation capability. This very same group of difficult to reach consumers tends to be avid consumers of smart phones. In the long run, it is inevitable that these smart phones will be the dominant form of cell phone. Accordingly, there is a need to bridge this gap between the increasing cost and difficulty of reaching some consumers with coupons and the greater pervasiveness of smart phones.

In addition, consumer products manufactures want to distribute coupons and special discounts to influence consumers' buying patterns and many segments of the consumer market are more and more difficult to reach. Accordingly, there is a need a coupon system that all consumers can benefit from and that is easier, more flexible and potentially less costly to use than the current paper based systems and methods.

### SUMMARY OF THE INVENTION

The above and other needs and problems are addressed by the present invention, which in an exemplary embodiment includes a system and method for distribution of consumer coupons through smart phones, and the like, both to the consumer and from the consumer to the retailer. The consumer registers through the Internet specifying the user's demographic information with the website of the coupon distribution company or agent. When the consumer goes to the retailer, the consumer uses the camera capability of the consumer's smart phone to input the barcodes of the products the consumer wants. The images of the bar codes are translated into the underlying bar code data and verified against the coupon database. If there is a coupon for the product in the coupon database, the coupon bar code is transferred to or generated on the smart phone. In a further exemplary embodiment, the coupon distribution company can interpret the bar code of the product and offer a coupon for a competing product in an effort to sway the consumer toward buying the competing product. When the consumer goes to the checkout, the products of the consumer are rung up at the cash register (e.g., at a point-of-sale terminal). The consumer then activates the smart phone's coupon display function and the coupons are then displayed on the smart phone such that they can be read by the cash register's optical scanner. In a further exemplary embodiment, the coupons can be transmitted to the cash register using other communication methods. Advantageously, the coupons are input into the smart phone, and generated based on what the consumer actually puts in their shopping cart. The system then displays the coupon's bar code which is scanned directly off the smart phone into the cash register for adjudication (e.g., verifying that the product actually purchased) and to credit the discount to the consumer.

Accordingly, in exemplary aspects of the present invention there is provided a system, method, and computer program product for promotion processing and delivery, including a smart phone having a capture function for capturing a product code of an item, wherein the smart phone is configured to generate and display a promotion having a barcode based on the captured product code of the item; and a point-of-sale terminal configured to read the displayed barcode of the promotion from the display of the smart phone, wherein the point-of-sale terminal applies the promotion based on the read barcode to a sales transaction.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary process for a user to select create an account with the coupon and/or promotions provider;

FIG. 2 illustrates an exemplary process for a user to log on with his smart phone to either download current promotions to his device or to set up access to the online central database of promotions;

FIG. 3 illustrates an exemplary process for a user to scan products while shopping and seek out coupons and promotions for his products;

FIG. 4 illustrates an exemplary process for a user to present his coupons at the cashier; and

FIG. 5 illustrates an exemplary system for implementing the processes of FIGS. 1-4.

### DETAILED DESCRIPTION OF THE PREFERRED EMBODIMENTS

Generally, the novel method and system described herein is a method and system for distributing coupons and other special offers through a smart phone based on the products the customer is face to face with in a retail establishment. For example, in a supermarket, the user uses the camera feature in his/her smart phone to first photograph the Universal Product Code (UPC) barcode and then interpret the photograph into its constituent barcode values which would be equivalent as if it were in fact scanned. This photographic processing can be avoided with smart phones that have native barcode reading capability. This scan (e.g., which can be a photograph and an image processing of the photograph to determine the UPC barcode) of the UPC barcodes of products is so that the method and system can determine if either coupons (e.g., discounts), special offers (e.g., buy 2 get 1 free) or other promotions (e.g., including promotions for competing products that might be in an effort to dissuade the purchase of the scanned item rather than encourage it or promotions for complementary products) are available for that product. For example, if the user scans one soft drink brand, the method and system might prompt a special discount for a competing brand's product or a complementary offer which would offer a discount for product that might be related or a simple discount off the price or a promotion to buy more of the same product at a discount (e.g., buy 2 get 1 free). The method and system can be adapted for items in the store using technologies other than barcodes for identification, such as Radio-Frequency Identification (RFID), and the like.

The smart phone can either have a local database of promotions or can use a wireless connection to a central database of such offers to determine what offers are available. Since smart phones typically have global positioning system (GPS) capability, promotions and discounts that are regional in nature can be identified based on the consumer's smart phone location, which can be determined by either GPS or some other location technology (e.g., cell tower triangulation, etc.).

As a consumer traverses a store and scans items, a database of electronic coupons is formed in the smart phone with the corresponding identifiers to be used to communicate the unique promotion codes that would be used at checkout. These unique promotion codes can be communicated through images (e.g., facsimile like) of the bar codes that are rendered and displayed on the smart phone's display and communicated through the cashier's optical scan based cash register or through other technology, such as RFID or direct radio frequency (e.g., wireless) or wired communication, and the like.

In the case of the optical scan and smart phone rendered images of barcodes, the consumer simply places the smart phone display side toward the optical bar code scanner of a cash register in use today. As the display flips through the display of a series of the barcodes representing coupons or other promotions, the cash register then performs a look up in its database for validation and then the appropriate credit based on the corresponding discounts is applied to the consumer's invoice (or e.g., register tape) for crediting the consumer with the discounts.

The method or system also can transmit the coupons or vouchers for promotions directly to the cash register at check out, for example, either though wired or wireless methods or by the facsimile like graphical generation of the barcodes, which can then be communicated to the cash register through the optical reader or scanner, wherein the cash register's optical reader or scanner reads the graphical image of the bar code displayed on the smart phone's display simulating a conventional paper coupon.

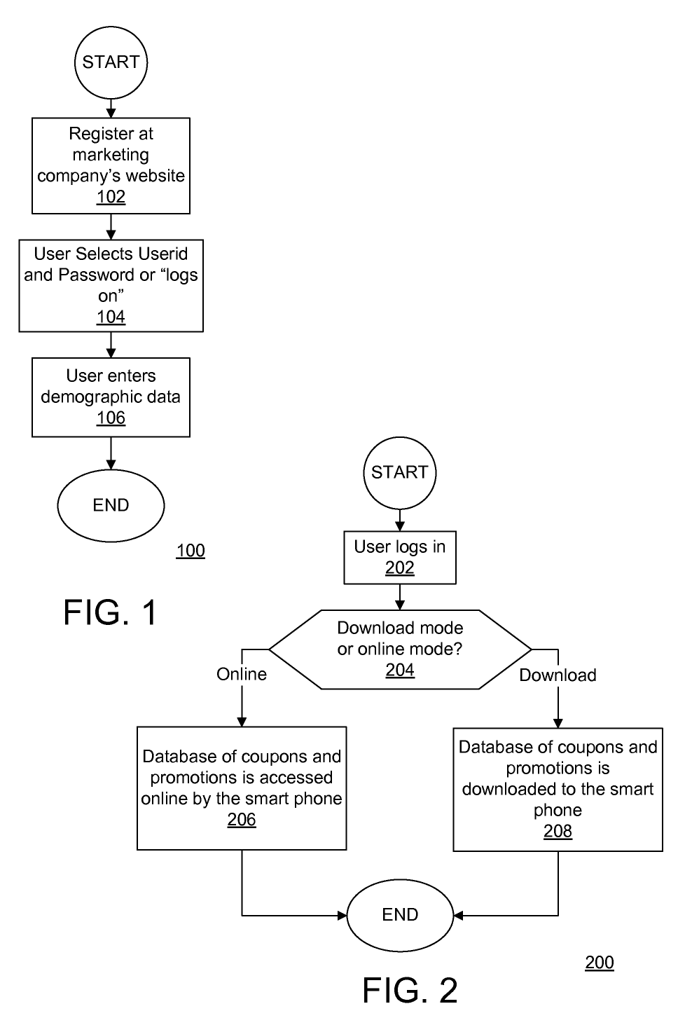

Referring now to the drawings, wherein like reference numerals designate identical or corresponding parts throughout the several views, and more particularly to FIG. 1 thereof, there is illustrated an exemplary user registration process 100. In FIG. 1, at step 102, a user starts the process by registering with a web site of the marketing service, and at step 104 the user selects a user identification (userid) and password or logs onto the web site using a previously generated user identification and password. In addition to selecting a userid and password, the user provides demographic information about the user (e.g., date of birth, home location, income, etc.) in step 106, completing the process.

FIG. 2 illustrates an exemplary process 200 for the user logging into the system, wherein two modes of operation are provided. In FIG. 2, at step 202, a user logs into the system. Step 204 then determines in which of “online” and “download” modes to operate. If the “online” mode is selected, products are scanned and coupons or promotions are looked up against an online database at step 206, completing the process. If the “download” mode is selected, the smart phone downloads a database of promotions selected for the user based on demographic or other factors, such as the user's previous buying history or buying patterns, at step 208, completing the process.

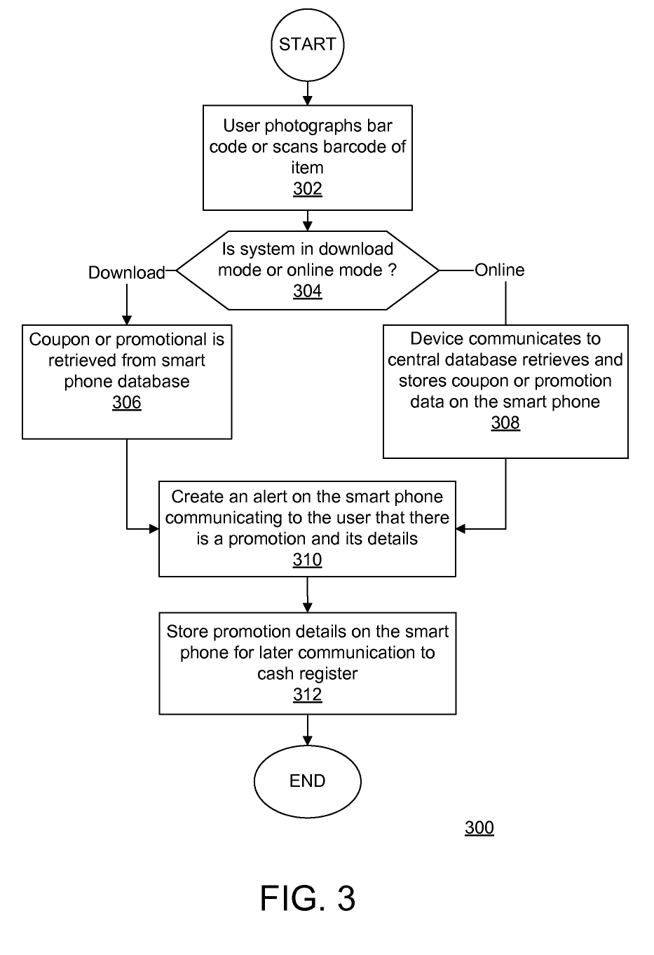

FIG. 3 illustrates an exemplary process 300 for the manner in which the user uses a smart phone to identify discounts, coupons and promotions. In FIG. 3, the item is scanned either optically or with another type of technology in step 302. Then, if the system is in the “download” mode, as determined by step 304, the item is looked up in the smart phone's database that exists on the smart phone itself, at step 306. If system is in the “online” mode, the item is looked up against a database that exists outside the smart phone and is connected to through a wireless network, at step 308. In either the “download” or “online” modes, the item then is validated against a database of discounts or promotions and those discounts and promotions are then accumulated in the smart phone for later transmittal to the cash register. The promotion or discount can be based not just on the item scanned, but also the history of the user's previous purchases, and the like.

When a discount or promotion exists for the scanned item, the user is notified at step 310 by an alert on the smart phone that informs the nature of the discount or promotion. A database of validated promotions then is created on the smart phone representing the items scanned and including the corresponding discounts and promotions and the terms and conditions of the discounts and promotions for later communication to the cash register, at step 312, completing the process.

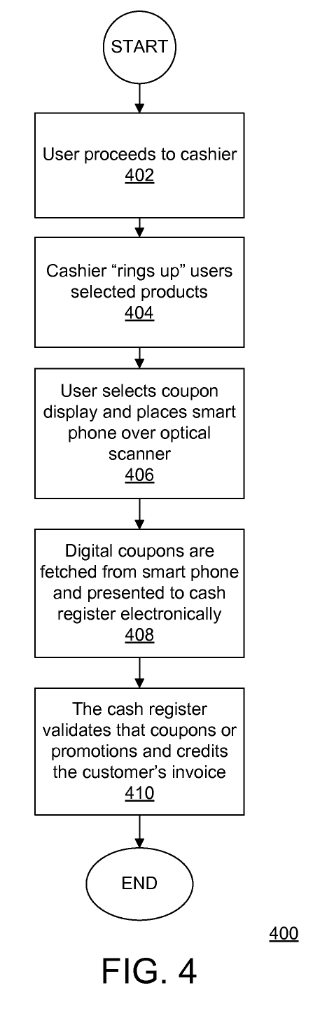

FIG. 4 illustrates an exemplary process 400 for the manner in which the user communicates accumulated discounts, coupons and promotions to the cashier at checkout. In FIG. 4, at step 402, the user proceeds to the check out area and the cashier rings up the selected items at step 404. Prior to concluding the check out process, the user's smart phone then communicates the discounts and promotions to the cash register at step 406. This can be facilitated by a wireless communication between the smart phone and the cash register or through the direct display of a bar code facsimile like image on the display of the smart phone for optical scanning through the cash register's optical scanning or bar code reading functionality. The bar codes can represent discounts and promotions already in the cash register database or newly determined discounts and promotions. At step 408, the digital coupons or promotions are fetched from smart phone and presented to cash register electronically. At step 410, the discounts and promotions are validated against a database of discounts and promotions accessible through the cash register system, and if validated, the user's invoice is adjusted accordingly to reflect the terms and conditions of the discount or promotion, completing the process.

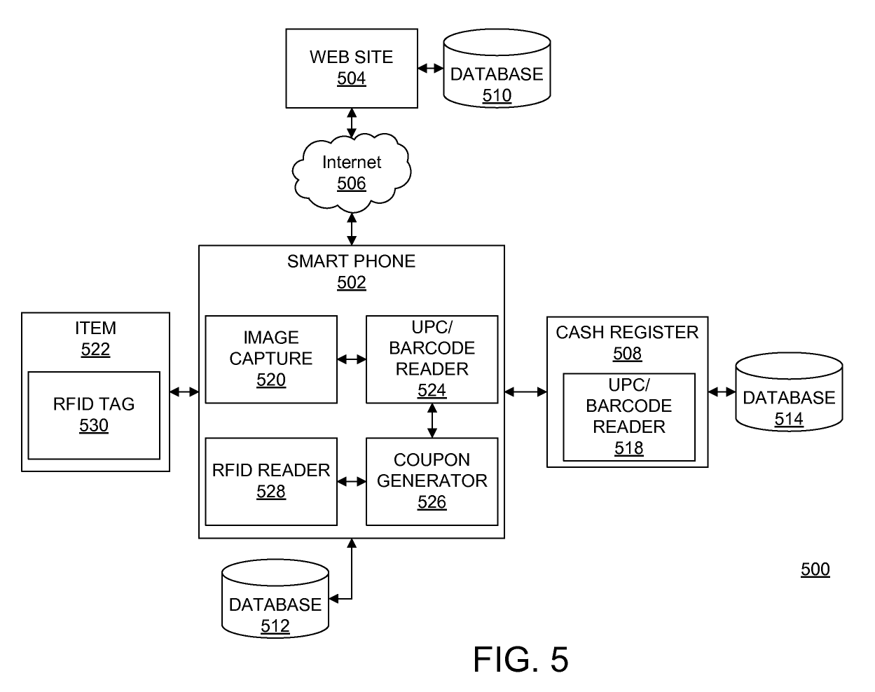

FIG. 5 illustrates an exemplary system 500 for implementing the processes of FIGS. 1-4. In FIG. 5, the system 500 can include a smart phone 502 that can communicate with a web site 504 (e.g., of the marketing service) over a communications network 506 (e.g., the Internet). The smart phone 502 also can communicate with a cash register 508, for example, including optical scanning bar code reading function 518. The web site 504 and the smart phone 502 can include respective databases 510 and 512 (e.g., of discounts and promotions). The cash register 508 can include a database 514 (e.g., from which the discounts and promotions are validated against). The smart phone 502 also includes an image capture function (e.g., still or video camera) for capturing an image of a UPC code of an item 522 and determining the UPC value for the item via a UPC/Barcode reader function 524. A coupon/promotion generation function 526 then generates a coupon/promotion for display on the smart phone 502 and which can be read from the display by the optical scanning bar code reading function 518 of the cash register 508. In a further exemplary embodiment, the smart phone 502 can also include an RFID reader function 528 for reading an RFID tag 530 from the item 522. The coupon/promotion generation function 526, based on the RFID value, can then generate the coupon/promotion for display on the smart phone 502.

Thus, with the exemplary system and method, a photo or image of a barcode of an item can be employed, wherein the barcode is parsed or recognized using optical character recognition (OCR), and the like, for determining the value of the underlying bar code. Coupons can be delivered directly to a smart phone (e.g., iPhone) and then displayed on the smart phone such that the coupons can be scanned directly into a cash register by the coupon scanner or reader of the cash register. For example, based on the items in a user's shopping cart a stack of coupons can be automatically generated for scanning at the cash register of a checkout counter at a point-of-sale.

In further exemplary embodiments, a local or national newspaper web site can provide the smart phone with a feed of coupons from their advertisers, and when the user goes to the store and scans the items in their cart the system and method automatically creates the corresponding coupons with bar codes that can be displayed by the smart phone to the scanner at the checkout line. In addition, competing product offers can be provided. For example, if the user scans a Coke product, the system and method automatically offers a special deal on a Pepsi product.

In further exemplary embodiments, a database of coupons can be downloaded to or preloaded on the smart phone or can be looked up online. In addition, products having an RFID instead of barcodes can be employed for determining the coupons to be generated. In the case of bar codes, optical character recognition (OCR) technology can be employed.

In further exemplary embodiments, GPS can be employed to determine the user's location so that local or only local promotions can be accessed. For example, Coke products may only have a specific promotion in a specific market.

In further exemplary embodiments, in addition to the use of smart phones, and the like, the exemplary system and method can be adapted for use with netbooks, and other classes of personal computers or personal productivity devices, and the like.

In further exemplary embodiments, rather than communicating all of the validated promotions to the cash register at checkout time, the smart phone can update and validate the promotions from a central system or store system wirelessly as the user shops.

In further exemplary embodiments, the smart phone can be used to scan items in a user's refrigerator, cupboard or elsewhere in the house for non-grocery items, and the like, and the service (e.g., via the web site) alerts the user of coupons, promotions, competitive promotions (e.g., Pepsi for Coke users), store specific (e.g., cheapest at store A versus store B) promotions, and the like, and downloads to or generates the corresponding digital coupons with barcodes on the smart phone display for scanning at the point-of-sale cash register or which can be printed out via PC for use at the point-of-sale cash register. In addition, the web site can inform the user through the smart phone, for example, that they should be shopping at store A rather than at store B (e.g., based on GPS or demographic information), including a report of which items should be purchased at which stores.

The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of appended claims.

What is claimed is:

1. A computer implemented system for promotion processing and delivery, the system comprising:
a smart phone having a capture function for capturing a product code of an item, wherein the smart phone is configured to generate and display a promotion having a barcode based on the captured product code of the item; and
a point-of-sale terminal configured to read the displayed barcode of the promotion from the display of the smart phone, wherein the point-of-sale terminal applies the promotion based on the read barcode to a sales transaction.

2. The system of claim 1, wherein capture function is an imaging function for image capturing the product code of the item and determining a value of the product code based on the captured image.

3. The system of claim 1, wherein capture function is a Radio-Frequency Identification (RFID) function for electronically capturing a value of the product code of the item.

4. The system of claim 1, wherein the smart phone has a global positioning system (GPS) function for determining the promotion based on a location of the smart phone.

5. The system of claim 1, wherein the product code of the item is captured by the smart phone at a home of a user or while the user is in a store.

6. A computer implemented method for promotion processing and delivery, the method comprising:
capturing a product code of an item via a capture function of a smart phone;
generating and displaying by the smart phone a promotion having a barcode based on the captured product code of the item;
reading by a point-of-sale terminal the displayed barcode of the promotion from the display of the smart phone; and
applying by the point-of-sale terminal the promotion based on the read barcode to a sales transaction.

7. The method of claim 6, wherein capture function is an imaging function for image capturing the product code of the item and determining a value of the product code based on the captured image.

8. The method of claim 6, wherein capture function is a Radio-Frequency Identification (RFID) function for electronically capturing a value of the product code of the item.

9. The method of claim 6, further comprising determining the promotion based on a location of the smart phone determined by a global positioning system (GPS) function of the smart phone.

10. The method of claim 6, further comprising capturing the product code of the item by the smart phone at a home of a user or while the user is in a store.

11. A computer program product for promotion processing and delivery, and including one or more computer readable instructions embedded on a tangible computer readable medium and configured to cause one or more computer processors to perform the steps of:
capturing a product code of an item via a capture function of a smart phone;
generating and displaying by the smart phone a promotion having a barcode based on the captured product code of the item;
reading by a point-of-sale terminal the displayed barcode of the promotion from the display of the smart phone; and
applying by the point-of-sale terminal the promotion based on the read barcode to a sales transaction.

12. The computer program product of claim 11, wherein capture function is an imaging function for image capturing the product code of the item and determining a value of the product code based on the captured image.

13. The computer program product of claim 11, wherein capture function is a Radio-Frequency Identification (RFID) function for electronically capturing a value of the product code of the item.

14. The computer program product of claim 11, further comprising determining the promotion based on a location of the smart phone determined by a global positioning system (GPS) function of the smart phone.

15. The computer program product of claim 11, further comprising capturing the product code of the item by the smart phone at a home of a user or while the user is in a store.
